(19) United States
(12) Patent Application Publication
(10) Pub. No.: US 2011/0111379 A1
(43) Pub. Date: May 12, 2011

(54) LIVESTOCK TRAINING AID

(76) Inventor: Lannie Ashley, Marshall, TX (US)

(21) Appl. No.: 12/942,738

(22) Filed: Nov. 9, 2010

Related U.S. Application Data
(60) Provisional application No. 61/260,056, filed on Nov. 11, 2009.

(51) Int. Cl. G09B 19/00; A01K 15/02

(52) U.S. Cl. 434/225; 119/839

(57) ABSTRACT

A livestock training aid includes a carriage having wheels that move along a set of tracks. The carriage has a livestock model mounted thereon. A first motor and first controller are provided to move the carriage on the tracks and control the speed and direction of the carriage movement. A second motor and second controller are provided on the carriage itself to move the model with respect to the carriage. The carriage also has a power storage device to provide power to the second motor and second controller. A charger is provided for the power storage device and is coupled to one of the wheels. The charger charges the power storage device when the carriage moves along the tracks. At least one of the controllers can store a sequence of commands for the carriage and the model movements, which commands can then be played back and executed. A livestock training aid is also provided for horseback riders. The horse model has a series of sensors for the rider to manipulate with the reins and legs and feet in order to control the movements of the horse model and its associated carriage.

This application claims the benefit of U.S. Provisional Patent Application Ser. No. 61/260,056, filed Nov. 11, 2009.

### FIELD OF THE INVENTION

The present invention relates to apparatuses and methods for training livestock such as horses.

### BACKGROUND OF THE INVENTION

Cutting horses are used to “cut” or segregate cattle or calves from the herd. Calves have a tendency to herd together, particularly when stressed. The cutting horse enters the herd and isolates one calf, moving it away from the herd. When one becomes separated, it tries to rejoin the herd. The cutting horse positions itself between the calf and the herd. The calf darts back and forth, changing direction in an attempt to get around the cutting horse.

Traditionally, cutting was used to cull calves for branding, inspection and other ranching activities. In modern times, cutting by horse has gained in popularity due to competitive events.

Cutting requires training for both the horse and the rider. As the calf darts back and forth, the horse and rider must match the calf's moves to block the calf's access to the herd. Training cutting horses involves using live calves. Unfortunately, the use of live calves is costly, as the calves and one or more human handlers must be hired or paid for. The high cost of training limits the ability of a horse and rider.

In the prior art, training aids have been used that emulate calves. An emulation of a calf acting under cutting conditions should replicate the movement of the calf, both in moving from side to side and also in turning to change direction. In the prior art, training aids use mechanical cables to move the calf back and forth. Any moving parts which require electrical power require power cables to be run thereto.

Cutting operations typically occur in arenas that have soft dirt for the ground. A cable on the dirt can be easily covered up with dirt that has been kicked, wherein the cable is either hidden or partially hidden from view. This increases the chances of a horse or human tripping or becoming entangled in the cable.

In addition, novice riders require much training to learn how to handle and control a cutting horse. The rider controls the movement and direction of the horse with the hands and feet. However, a cutting horse can only withstand a practice session of cutting for 10 to 20 minutes because of the intense physical nature of the activity. Therefore, a rider must change horses in order to train for any extended length of time. This adds to the cost of training.

### SUMMARY OF THE INVENTION

The present invention provides a livestock apparatus that comprises a carriage having wheels for moving along rails. The carriage has a livestock model rotatably mounted thereon. A first motor is positioned so as to move the carriage along the rails in more than one direction, while a second motor is positioned so as to rotate the model on the carriage. The model has two sides and a front end and a rear end. The model has a seat thereon to allow a human rider to sit and straddle the model. A controller communicates with and controlling the first and second motors.

In another aspect, the livestock model emulates a cutting horse in its movement on the rails.

In another aspect, the controller is operated by a human located off of the livestock model.

In another aspect, the controller is operated by a human located on the livestock model.

In another aspect, the controller comprises a memory, the memory storing programming to operate the controller.

In another aspect, the controller is a hand held controller.

In another aspect, each side of the model comprises first and second sensors, with the first sensor used to create a command for the carriage to move and the second sensor used to create a command for the model to rotate relative to the carriage, with one of the first and second sensors being located nearer to the front end than the other of the first and second sensors. The controller communicates with the each of the respective first and second sensors.

In another aspect, the model has reins, the model having a halt sensor that is activated by the reins. The controller communicates with the halt sensor.

In another aspect, the model has reins, the model comprising right and left turning sensors. The turning sensors are activated by the reins.

In another aspect, each side of the model has a third sensor used to create a command for the model to rotate relative to the carriage, on each side of the model, the first sensor being interposed between the second and third sensors.

A method of operating a livestock apparatus, comprises the steps of providing a wheeled carriage that is movable on tracks with a livestock model on the carriage; providing a first motor that moves the carriage along the rails in more than one direction; providing a second motor that rotates the model on the carriage; providing a controller in communication with the first and second motors, the controller having memory; providing inputs for manually generated commands to the controller for operating the first and second motors; and operating the first and second motors according to the commands. The controller having a learn mode wherein the manually generated commands are stored in the memory. The first and second motors are operated according to the stored commands.

A livestock apparatus comprises a first carriage with a first livestock model rotatably mounted thereon, the first carriage having wheels for moving along a first track. A first motor is positioned so as to move the first carriage relative to the ground in more than one direction. A second motor is positioned so as to rotate the first livestock model on the first carriage. The first livestock model has a seat thereon to allow a human rider to sit. A second carriage has a second livestock model rotatably mounted thereon, the second carriage having wheels for moving along a second track. A third motor is positioned so as to move the second carriage relative to the ground in more than one direction. A fourth motor is positioned so as to rotate the second livestock model on the second carriage. At least one controller communicates with and controls the first, second, third and fourth motors, with the second livestock model moving independently of the first livestock model.

In another aspect, the first livestock model emulates a cutting horse in its movement on the first track and the second livestock model emulates a calf in its movement on the second track.

In another aspect, there is a remote controller in communication with the controller for controlling the first, second, third and fourth motors.

In another aspect, the controller comprises a memory, the memory storing programming to operate the controller.

In another aspect, the first livestock model has reins, the first livestock model having a halt sensor that is activated by the reins. The first livestock model having two sides and a front end and a rear end, with each side comprising first and second sensors, with the first sensor used to create a command for the first carriage to move and the second sensor used to create a command for the first livestock model to rotate relative to the first carriage, with one of the first and second sensors being nearer the front end than the other of the first and second sensors.

A livestock training aid comprises a carriage. The carriage has a livestock model rotatably mounted thereon. The carriage has wheels for moving. A first motor is positioned so as to move the carriage relative to ground in more than one direction. A second motor is positioned so as to rotate the model on the carriage. At least one controller communicates with the first motor and controls the first motor and communicates with the second motor and controls the second motor. A power storage device is provided on the carriage so as to move with the carriage. The power storage device is connected to the second motor. A charger is connected to the power storage device and coupled to one of the wheels. The charger charges the power storage device when the carriage moves relative to the ground.

In accordance with one aspect of the present invention, the livestock training aid further comprises a set of rails. The carriage is located so as to move along the rails. The wheels are in rolling contact with at least a portion of the rails.

In accordance with still another aspect, an axle is coupled to at least one wheel. The charger is coupled to the axle.

In accordance with still another aspect, the at least one controller comprises a first controller connected to the first motor and a second controller connected to the second motor. The second controller is located on the carriage and in communication with the first controller.

In accordance with still another aspect, the second controller is in wireless communication with the first controller.

There is also provided a method of operating a livestock training aid. A wheeled carriage is provided with a livestock model thereon. A power storage device is provided on the carriage. The carriage is moved relative to the ground. The power storage device is charged using the movement of the carriage relative to the ground. Power is drawn from the storage device to move the livestock model relative to the carriage.

In accordance with one aspect, the step of moving the carriage relative to the ground further comprises moving the carriage on the wheels on tracks over the ground. The step of charging the power storage device further comprised using the rotation of at least one of the wheels to charge the power storage device.

In accordance with still another aspect, a sequence of commands for moving the carriage relative to the ground and for moving the livestock model relative to the carriage is stored. Then the stored sequence of command is executed.

### BRIEF DESCRIPTION OF THE DRAWINGS

FIG. 1 is a plan view of the training aid of the present invention, in accordance with a preferred embodiment.

FIG. 2 is a section view taken at lines II-II of FIG. 1.

FIG. 3 is a side view of the carriage.

FIG. 4 is a block diagram of the electrical components of the training aid of FIGS. 1 and 3.

FIG. 5 shows a hand controller used in conjunction with the components of FIG. 4.

FIG. 6 is a plan view of the calf and horse training aids.

FIG. 7 is a side view of the horse carriage.

FIG. 8 is a block diagram of the electrical components of the horse training aid of FIG. 6.

### DESCRIPTION OF THE PREFERRED EMBODIMENTS

The present invention provides a livestock training aid 11. In particular, the training aid 11 emulates the movements and actions of a calf. Cutting horses and riders are able to train in cutting operations and techniques without the need and expense of using live calves.

The present invention can move the livestock model in various manners while minimizing the use of cables and thus minimizing the possibility of a cable interfering with a horse or personnel. The carriage containing the livestock model needs no off-carriage power supply and thus needs no electrical power cables running off of the carriage. With the present invention, all of the cables, whether mechanical or power, are confined to the unit. Furthermore, the carriage can operate at a fast speed, that is at a speed that emulates an actual calf.

The livestock training aid 11 includes a carriage guide system 13, a carriage 15, motors 17, 19 and controllers 21, 23. These components will now be discussed in turn.

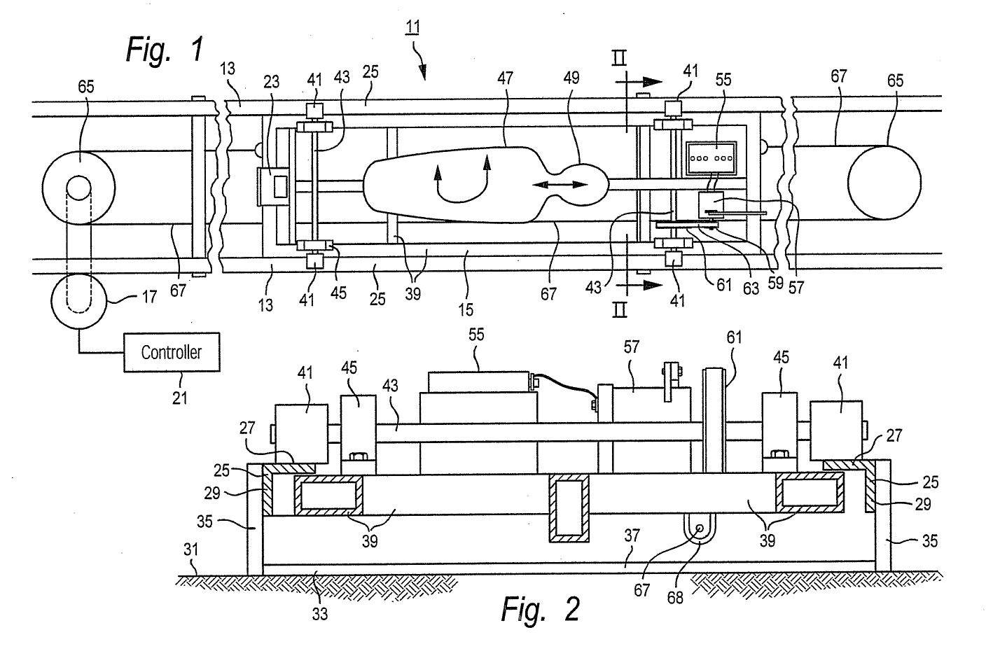

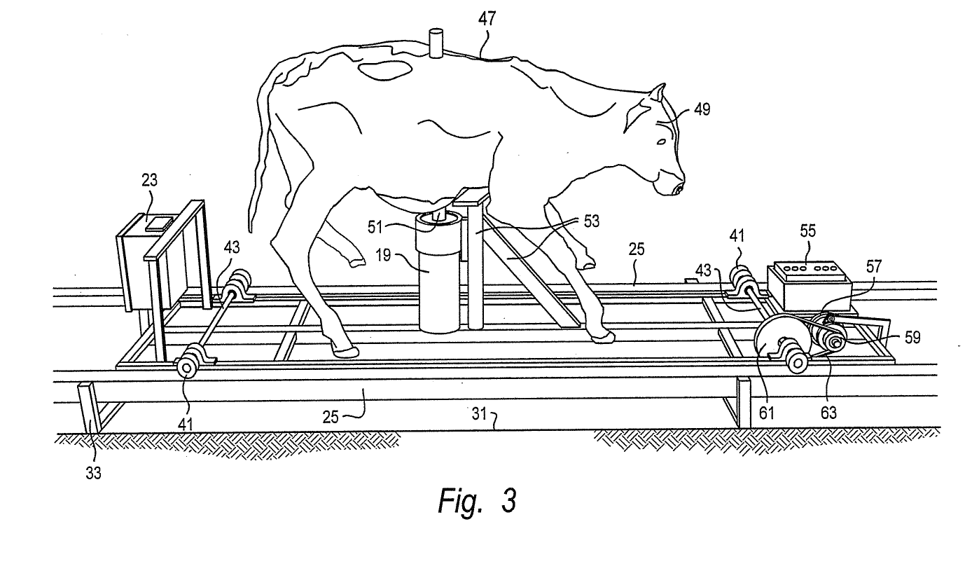

Referring to FIGS. 1-3, the carriage guide system 13 is in the preferred embodiment a set of tracks 25. Each track 25 is a length of angle iron, oriented like an upside down “L” or reversed upside down “L” when viewed on the end. Thus, each track has a top horizontal piece or flange 27 and a vertical, downwardly descending flange 29. The horizontal flanges 27 extend inwardly toward the opposite track. The tracks 25 are elevated above the ground 31 by supports 33. Each support is shaped like a shallow “U”, with vertical legs 35 of the support coupled to the outside of the vertical flanges 29 of the tracks. The vertical legs 35 of the support are coupled to a horizontal bar 37 which bears on the ground 31. The supports 33 space the tracks apart the desired distance and elevate the tracks above ground level a short distance.

The tracks 25 can be of any length. A typical length is 80-120 feet. The tracks 25 can be made in sections of shorter lengths in order allow disassembly in moving the tracks from one arena to another or from one location to another in the same arena. The tracks can provide a straight path or a curved path.

The carriage 15 has a chassis 39 that fits between the tracks 25. The chassis, which is generally rectangular in shape, is located beneath the horizontal flanges 27. The chassis is suspended under the tracks by rollers or wheels 41; the wheels roll on top of the track horizontal flanges 27. There are two sets of wheels 41, with each set located near an end of the chassis. The wheels of each set are coupled together by shaft 43 or axle with the respective shaft mounted by way of bearings 45 to the chassis.

The carriage chassis supports a model 47 of livestock. The model is a representation or likeness of the livestock. In the preferred embodiment, the model is a three-dimensional figure of a calf, having a body, a head 49 and legs and even a tail. The model can be provided with realistic coloration. In the preferred embodiment, the model has no articulating components and is a stiff figure. In other embodiments, the model can be provided with an articulating head, legs, etc. The model can also be provided with a speaker to make appropriate calf or other noises.

The model 47 is supported above the chassis in a natural orientation, with the feet down. The model 47 is mounted on a shaft 51. The shaft is turned or rotated by a carriage motor 19. The carriage motor 19 is mounted to supports 53 and in the preferred embodiment is oriented vertically. The motor shaft directly drives the model shaft 51. In the preferred embodiment, the motor 19 rotates the model 47 about 180 degrees, so that the head 49 can face in both directions of the tracks 25.

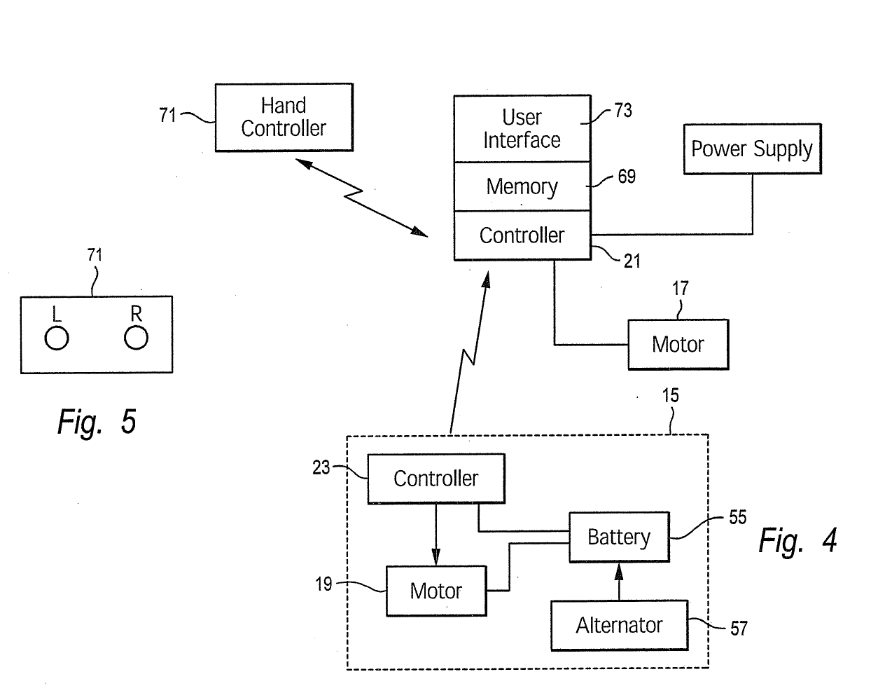

As shown in FIG. 4, the carriage motor 19 is connected to a carriage controller 23. The model 47, the motor 19 and the controller 23 move with the carriage 15.

In order to provide electrical power to the motor 19 and controller 23, a battery 55, or other power source device, and battery charger 57 are provided on the carriage 15. The battery 55 is of the 12-volt lead acid type. The battery charger 57 is an alternator and is connected to the battery. The alternator 57, which can be of the same type as used in an automotive vehicle, has a sheave 59 which is coupled by way of a belt 63 to another sheave 61 on one of the wheel shafts 43. As the carriage moves along the track, the wheels 41 are in contact with the tracks and rotate; the shaft 43 in turn rotates the pulleys 59, 61 and the belt 63 and the alternator rotor is rotated. The alternator 57 produces electrical power that is used to charge the battery 55. In this manner, the carriage can operate to rotate the model for extended lengths of time, without the need to interrupt carriage operations to replace or recharge the battery and without the need for a power cable leading to an off-carriage power supply.

Although the model has been described as rotating with respect to the carriage, other types of model movement can be provided and powered by the battery 55 and charging system 57.

The carriage 15 is moved along the tracks 25 by a track motor 17, and a cable and pulley system (see FIG. 1). A pulley 65 is provided at each end of the tracks. A mechanical cable 67 forms an endless loop around the pulleys, with the carriage between the pulleys. Thus, one end of the cable extends from one end of the carriage, around the pulley that is closest to that end, to the other pulley and around to the other end of the carriage. As the cable passes through the carriage between the two pulleys, it is routed beneath the carriage so as not to get snagged and may be routed through guides 68 on the carriage. The motor 17 rotates one of the pulleys 65 either directly or indirectly such as by way of a speed reducer or a belt and pulley arrangement (as shown in FIG. 1). When the motor rotates the respective pulley in one direction, the carriage is moved along the tracks in a first direction. When the motor rotates the respective pulley in the other direction, the carriage moves along the tracks in a second direction that is opposite of the first direction.

FIG. 4 shows a block diagram of the electrical components of the training aid. The carriage based components, discussed above, are shown within a dashed line box representative of the carriage 15. The track motor 17 that drives one of the track pulleys has a controller 21; these components are mounted to the track in a place where they will not interfere with the carriage movement, typically at an end of the tracks. The track controller 21 has memory 69 therein so as to be able to store preprogrammed sequences of commands of movement of the carriage and model.

Although two controllers 21, 23 are shown, the training aid could use just one controller that operates both motors. The one controller could be attached to the track or to the carriage and in wireless communication with the other motor.

A hand controller 71 is also provided to allow manual operation of a model 47. A hand controller 71 is used by a human operator who typically has a view of the model and the cutting horse and rider who are training with the model. The hand controller communicates with the pulley controller either by an electrical cable or by a wireless communications link. In FIG. 4, a wireless link is shown. Referring to FIG. 5, the hand controller 71 is sized so as to be held in one hand or worn on a wrist. There are two buttons, namely a left button and a right button. The hand controller 71 is intended to be used by an operator facing the tracks in the same manner as the cutting horse rider. As used herein, “left” and “right” are used with respect to the orientation that a horse rider views the model 47. Each button on the hand controller controls a two-speed switch. Each button produces a slow speed and a faster speed. Pressing one button causes the carriage to move in one direction along the tracks. Pressing the other button causes the carriage to move in the opposite direction on the tracks. Pressing a button once causes the carriage to move at a slow speed; pressing the button twice moves the carriage at a faster speed. The hand held controller 71 can be used to control the horse model by a human that is a non-rider and located off of the horse. For example the non-rider can control the operation of the horse while another human is riding the horse. In the alternative, the controller 71 can be used by a rider on the horse.

In the preferred embodiment, the track controller 21 is a master controller and the carriage controller 23 is a slave controller. The track controller receives the commands from the hand controller. The track controller implements the commands for track direction and speed by controlling the track motor 17. If there is a change in direction of the carriage on the tracks, the track controller 21 sends a command to the carriage controller to rotate the model 47. The two controllers 21, 23 communicate with one another over a wireless communications link.

As an example of the operation, suppose the operator is facing the track and presses the left button once. The track controller 21 operates the track motor 17 to rotate the pulley in the proper direction. The carriage 15 moves left along the track with the head of the model pointed in the direction of travel. If the operator presses the left button twice, instead of once, then the track controller causes the track motor to operate faster and the carriage moves to the left at a faster speed. Pressing the right button once causes the carriage to move to the right at a slow speed, as the track motor reverses direction. Pressing the right button twice causes the carriage to move to the right at a faster speed.

When the carriage 15 changes direction, from moving to the left and then to the right or from moving to the right to the left, the model 47 rotates on the carriage to face the new direction. The track controller 21 sends a signal to the carriage controller 23, wherein the carriage motor 19 rotates the model 47 accordingly. In this manner, the model heads in the new direction.

The timing of the model rotation can be adjusted and depends on the speed of the direction change. For example, if the model was moving slow to the left and a right slow command (pressing the right button in the hand controller 71 once) is given, the carriage comes to a stop, the model pivots to face the right and the carriage moves to the right. Alternatively, the carriage can come to a stop and move to the right a short distance before the model rotates to put the head in the forward direction. This maneuver gives the appearance of a calf stopping, backing up and then pivoting to move in a new direction.

The speed of the model rotation can also be adjusted. In the preferred embodiment, the speed of the model rotation is determined by the change in direction speed. For example, if the carriage moves one direction at a slow speed and then changes direction to move again at a slow speed, then the model may rotate to the new direction at a slow speed. If the carriage moves one direction at a slow speed and then changes direction to move at a faster speed, the model rotates to the new direction at a faster speed. If the carriage moves in one direction at a fast speed and then changes direction to move at a slower speed, then the model rotates to the new direction at either a slow or faster speed, depending upon the programming determination.

An example of an exercise involves the carriage and model moving as follows:

| carriage movement | model rotation |
|---|---|
| left slow | |
| left fast | |
| left slow | |
| right fast | right fast |
| right slow | |
| right fast | |
| left fast | left fast |
| right fast | right fast |
| left slow | left slow |
| etc. | |

(The Directions are from the Orientation of the Rider Using the Training Aid.) The cutting horse and the rider are supposed to keep up with the model, matching direction and speed. For example, as the calf model moves to the right, the horse moves to the right at about the same speed.

The track controller 21 has a user interface 73 (see FIG. 4). A user can select one of three modes. One mode is a remote controller mode, described above with respect to the hand controller 71. Another mode is a learn mode, where the operation is controlled by the hand controller, with the sequence of commands stored in the memory 69 of the track controller 21. The controller can store a number of sequences of direction and travel, speed of travel and duration of each direction and speed, with associated model rotations. Another mode is playback mode where a selected one of the stored sequences is implemented. The stored sequences can be graded according to difficulty, such as easy-1, easy-2, easy-3, intermediate-1, difficult-1, and difficult-2. The number of stored sequences depends on the capacity of the memory. The user interface 73 is used to select the particular sequences that is to be executed.

The model described above with respect to FIGS. 1-3 is a target, wherein the cutting horse and rider focus on and track the model. The present invention also provides a training aid for horse riders and in particular for cutting horse riders. Cutting horse riders are able to train in handling a horse under cutting conditions without the need for a live horse. Thus, a rider can train for longer periods of time than would be possible when using a live horse.

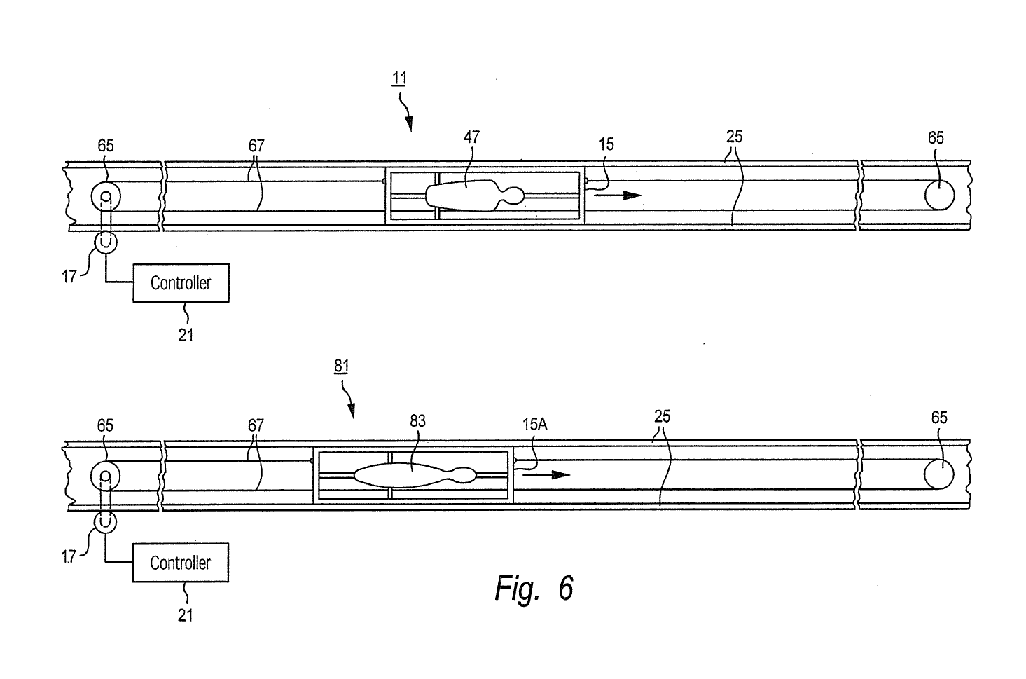

FIG. 6 illustrates the calf training aid 11 and an adjacent horse training aid 81. Each training aid 11, 81 has a set of tracks 25 and a carriage 15, 15A that moves along the respective tracks. (Note that like reference numbers represent like components between the various embodiments and training aids.) The two sets of tracks are typically parallel to each other. The two sets of tracks are spaced apart an appropriate distance, such as 15-30 feet. The carriage of the horse training aid has a horse model 83 thereon. The horse training aid is similar to the calf training aid and has a track motor 17 and a controller 21 at one end of the track, a carriage motor 19 and a controller 23A on the carriage 15A to pivot the horse model. The horse carriage can be provided with an onboard power supply in the form of a battery 55 and an alternator charger 57. Alternatively, the horse carriage can be powered by an electrical cable that extends to a power supply such as an electrical outlet.

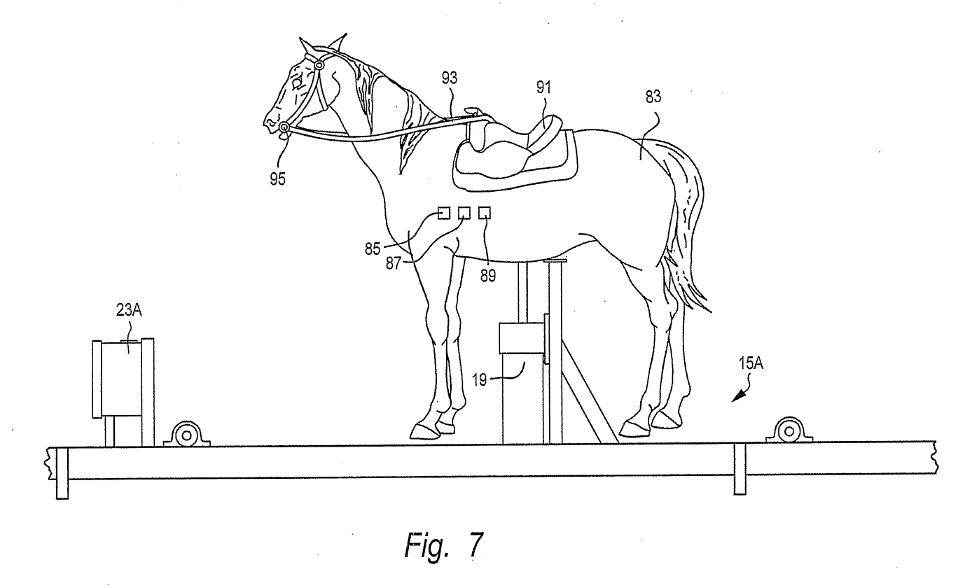

In addition, the horse model 83 (see FIG. 7) is equipped with sensors or switches for use in controlling the horse. Each side of the horse is provided with a forward sensor 85, an intermediate sensor 87 and a rear sensor 89, all located along the side of the horse and located so that the leg or foot of a rider can press against the sensors to activate them. In the preferred embodiment, the sensors are two-speed switches, having a slow speed and a fast speed. The horse model 83 has a seat in the form of a saddle 91 for a rider and reins 93. The saddle is a conventional riding saddle such as a western saddle (in FIG. 7, the stirrups are not shown so as to view the sensors). The ends of the reins couple to the horse by way of sensors 95, which sensors detect a pulling on the reins. The sensors 95 can function as halt sensors wherein when the rider pulls the reins the horse stops moving on the tracks. The sensors 95 can also function as turning sensors, wherein when the rider tugs the reins in one direction the horse turns to move in that direction. For example, if the rider tugs the reins to the left then the horse will rotate in that direction. A seat belt may be used to strap the rider to the seat and the horse. The horse model emulates a cutting horse in its movements. A cutting horse moves quickly, with sudden acceleration, sudden stopping and sudden turning. The rider holds on primarily with his legs as the horse goes through its movements. Failure to properly hold on can result in the rider falling off of the horse.

The motor 19 on the horse carriage provides the mechanical power needed to rotate the horse model 83 loaded with a human rider.

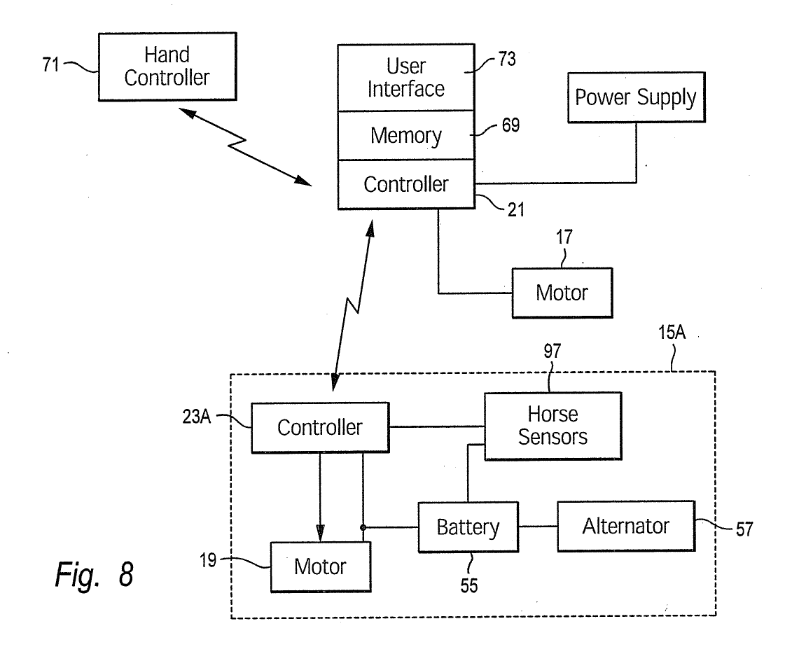

FIG. 8 shows a block diagram with the electrical components of the horse training aid 81. The aid has a track motor 17 and track controller 21. In addition, the aid has a carriage controller 23A which communicates with the track controller 21. The two controllers can communicate over a wireless communication link as shown or by an electrical cable or wire. The carriage controller 23A is connected to the horse sensors 97. In the preferred embodiment, there are eight horse sensors 97, namely two rein sensors 95, two forward sensors 85, two intermediate sensors 87 and two rear sensors 89. The carriage controller 23A receives the sensor 97 inputs and based on these inputs controls the carriage motor if a change in direction is called for and sends information to the track controller 21 so that the track controller can control the track motor 17 as to direction and speed of the carriage 15A.

In operation of the horse model 83, the rider climbs on and sits in the saddle 91 and holds the reins 93. To make the horse model go forward, the rider uses both feet to press the intermediate sensors 87; the sensor input is passed from the carriage controller 23A to the track controller 21 which in turn operates the track motor 17 to move the horse carriage and the horse model along the track. The rider can control the speed by pressing the intermediate sensors 87 once for a slow speed or twice for a faster speed. If the rider pulls on the reins 93, the rein sensors 95 detect this and the horse carriage will stop as the motor 17 stops rotating. To make the horse turn, say to the left, the rider presses on the right rear sensor 89 or on the left front sensor 85 or on both. The signals are input into the carriage controller 23A which controls the carriage motor 19 to rotate the horse in the proper direction. The signals are also passed from the carriage controller 23A to the track controller 21 to advise of the change in direction. To make the horse turn to the right, the rider presses on the left rear switch or the right forward switch or both. When the horse is turned, the rider presses the intermediate switches 87 to make the horse move forward again.

The horse model can alternatively be controlled by an operator on the ground and not on the horse model. For example, if a student rider wishes to obtain a feel for how the horse should move relative to the calf model, the student simply sits on the horse model and allows an operator or trainer to control the horse model. The calf training aid 11 is controlled by the same operator, a second operator, or operates in the playback mode under a preprogrammed sequence of commands. The horse model tracks the movement and direction of the calf model so that the rider can gain experience.

The carriage controller 23A has several modes, such as a rider mode, where the rider controls the movement of the horse carriage using the sensors 97 on the horse model, a remote mode, where a remote operator uses a remote controller to control the horse carriage and a learn mode where commands can be stored for later use in a playback mode. The remote controller 71 is substantially the same as shown and described with reference to FIG. 5.

The two training aids 11, 81 operate independently of each other. For example, the calf model moves in a manner that is independent of the horse model and vice versa. This allows the horse rider to “miss a calf” wherein, the calf model is able to outmaneuver and get beyond the horse model. This emulates the situation in an actual cutting operation where the calf can run around the horse.

The setup shown in FIGS. 6-8 provides entertainment to a rider and onlookers. A rider can mount the horse model 83 and, as the calf model moves independently of the horse model, try to track and follow the movements of the calf model with the horse model. If the rider is a novice, the horse model can be remotely controlled, either manually or automatically by a pre-programmed sequence. If the rider is more skilled or adventurous, then the rider can control the horse model from the model itself using the controls.

The foregoing disclosure and showings made in the drawings are merely illustrative of the principles of this invention and are not to be interpreted in a limiting sense.

1. A livestock apparatus, comprising:
a) a carriage having wheels for moving along rails, the carriage having a livestock model rotatably mounted thereon;
b) a first motor positioned so as to move the carriage along the rails in more than one direction;
c) a second motor positioned so as to rotate the model on the carriage;
d) the model having two sides and a front end and a rear end, the model having a seat thereon to allow a human rider to sit and straddle the model;
e) a controller communicating with and controlling the first and second motors.

2. The livestock apparatus of claim 1 wherein the livestock model emulates a cutting horse in its movement on the rails.

3. The livestock apparatus of claim 1 wherein the controller is operated by a human located off of the livestock model.

4. The livestock apparatus of claim 1 wherein the controller is operated by a human located on the livestock model.

5. The livestock apparatus of claim 1 wherein the controller comprises a memory, the memory storing programming to operate the controller.

6. The livestock apparatus of claim 1 wherein the controller is a hand held controller.

7. The livestock apparatus of claim 1, wherein:
a) each side of the model comprises first and second sensors, with the first sensor used to create a command for the carriage to move and the second sensor used to create a command for the model to rotate relative to the carriage, with one of the first and second sensors being located nearer to the front end than the other of the first and second sensors;
b) the controller communicating with the each of the respective first and second sensors.

8. The livestock apparatus of claim 7, wherein:
a) the model has reins, the model having a halt sensor on the horse that is activated by the reins;
b) the controller communicating with the halt sensor.

9. The livestock apparatus of claim 7, wherein the model has reins, the model comprising right and left turning sensors, which turnings sensors are activated by the reins.

10. The livestock apparatus of claim 7, wherein each side of the model has a third sensor used to create a command for the model to rotate relative to the carriage, on each side of the model, the first sensor being interposed between the second and third sensors.

11. A method of operating a livestock apparatus, comprising the steps of
a) providing a wheeled carriage that is movable on tracks with a livestock model on the carriage;
b) providing a first motor that moves the carriage along the rails in more than one direction;
c) providing a second motor that rotates the model on the carriage;
d) providing a controller in communication with the first and second motors, the controller having memory;
e) providing inputs for manually generated commands to the controller for operating the first and second motors;
f) operating the first and second motors according to the commands;
g) the controller having a learn mode wherein the manually generated commands are stored in the memory;
h) operating the first and second motors according to the stored commands.

12. A livestock apparatus, comprising:
a) a first carriage with a first livestock model rotatably mounted thereon, the first carriage having wheels for moving along a first track;
b) a first motor positioned so as to move the first carriage relative to the ground in more than one direction;
c) a second motor positioned so as to rotate the first livestock model on the first carriage;
d) the first livestock model having a seat thereon to allow a human rider to sit;
e) a second carriage with a second livestock model rotatably mounted thereon, the second carriage having wheels for moving along a second track;
f) a third motor positioned so as to move the second carriage relative to the ground in more than one direction;
g) a fourth motor positioned so as to rotate the second livestock model on the second carriage;
h) at least one controller communicating with and controlling the first, second, third and fourth motors, with the second livestock model moving independently of the first livestock model.

13. The livestock apparatus of claim 12 wherein the first livestock model emulates a cutting horse in its movement on the first track and the second livestock model emulates a calf in its movement on the second track.

14. The livestock apparatus of claim 12 further comprising a remote controller in communication with the controller for controlling the first, second, third and fourth motors.

15. The livestock apparatus of claim 12 wherein the controller comprises a memory, the memory storing programming to operate the controller.

16. The livestock apparatus of claim 12 wherein:
a) the first livestock model has reins, the first livestock model having a halt sensor that is activated by the reins;
e) the first livestock model having two sides and a front end and a rear end, with each side comprising first and second sensors, with the first sensor used to create a command for the first carriage to move and the second sensor used to create a command for the first livestock model to rotate relative to the first carriage, with one of the first and second sensors being nearer the front end than the other of the first and second sensors.

17. A livestock training aid, comprising:
a) a carriage with a livestock model rotatably mounted thereon, the carriage having wheels for moving;
b) a first motor positioned so as to move the carriage relative to ground in more than one direction;
c) a second motor positioned so as to rotate the model on the carriage;
d) at least one controller communicating with the first motor and controlling the first motor and communicating with the second motor and controlling the second motor;
e) a power storage device on the carriage so as to move with the carriage, the power storage device connected to the second motor;
f) a charger connected to the power storage device and coupled to one of the wheels, the charger charging the power storage device when the carriage moves relative to the ground.

18. The livestock training aid of claim 17 further comprising a set of rails, the carriage located so as to move along the rails, the wheels being in rolling contact with at least a portion of the rails.

19. The livestock training aid of claim 18 further comprising an axle coupled to the at least one wheel, the charger coupled to the axle.

20. The livestock training aid of claim 17 wherein the at least one controller comprises a first controller connected to the first motor and a second controller connected to the second motor, the second controller being located on the carriage and in communication with the first controller.

21. The livestock training aid of claim 17 wherein the second controller is in wireless communication with the first controller.

22. A method of operating a livestock training aid, comprising the steps of:
a) providing a wheeled carriage with a livestock model thereon;
b) providing a power storage device on the carriage;
c) moving the carriage relative to the ground;
d) charging the power storage device using the movement of the carriage relative to the ground;
e) drawing power from the storage device to move the livestock model relative to the carriage.

23. The method of claim 22, wherein:
a) the step of moving the carriage relative to the ground further comprises the step of moving the carriage on the wheels on tracks over the ground;
b) the step of charging the power storage device further comprising the step of using the rotation of at least one of the wheels to charge the power storage device.

24. The method of claim 22, further comprising the step of:
a) storing a sequence of commands for moving the carriage relative to the ground and moving the livestock model relative to the carriage;
b) executing the sequence of commands.
